(19) United States
(12) Patent Application Publication
(10) Pub. No.: US 2025/0200857 A1
(43) Pub. Date: Jun. 19, 2025

(54) ANIMATION EFFECT GENERATION METHOD AND APPARATUS, DEVICE, AND MEDIUM

(71) Applicant: Beijing Zitiao Network Technology Co., Ltd., Beijing (CN)

(72) Inventors: Yibo XU, Beijing (CN); Hantong XU, Beijing (CN); Tianjing LI, Beijing (CN); Yameng LI, Beijing (CN); Yi CHEN, Beijing (CN)

(21) Appl. No.: 18/845,820

(22) PCT Filed: Mar. 2, 2023
(86) PCT No.: PCT/CN2023/079276

§ 371 Date: Sep. 10, 2024

(30) Foreign Application Priority Data
Mar. 10, 2022 (CN) 202210231529.9

(51) Int. Cl. G06T 13/80

(52) U.S. Cl. CPC G06T 13/80

(57) ABSTRACT

Embodiments of the present disclosure relate to an animation effect generation method and apparatus, a device, and a medium. The animation effect generation method includes: acquiring an image frame file of a target object and a configuration file, wherein the image frame file comprises a plurality of image frames and playing times of the image frames; generating an animation file based on the plurality of image frames, the playing times of the image frames and the configuration file and playing the animation file; acquiring effect image frame(s) in a process of playing the animation file; and controlling the effect image frame(s) to play based on a preset shooting parameter.

### CROSS-REFERENCE TO RELATED APPLICATIONS

The present disclosure is a U.S. National Stage Application under 35 U.S.C. § 371 of International Patent Application No. PCT/CN2023/079276, filed on Mar. 2, 2023, which is based on and claims priority of Chinese application for invention No. 202210231529.9, filed on Mar. 10, 2022, the disclosure of which is hereby incorporated into this disclosure by reference in its entirety.

### BACKGROUND

With the rapid development of Internet technology and intelligent terminals, online effects videos can be provided to users.

In the related art, users shoot a video through a terminal, and select the effects material provided by the platform to fuse with the video to get the video with effects.

### SUMMARY

The embodiment of the present disclosure provides an animation effect generation method, which comprises:

acquiring an image frame file of a target object and a configuration file, wherein the image frame file comprises a plurality of image frames and playing times of the image frames;

generating an animation file based on the plurality of image frames, the playing times of the image frames and the configuration file and playing the animation file;

acquiring effect image frame(s) in a process of playing the animation file; and

controlling the effect image frame(s) to play based on a preset shooting parameter.

The embodiment of the present disclosure also provides an animation effect generation apparatus, which comprises:

a first acquisition module configured to acquire an image frame file of a target object, wherein the image frame file comprises a plurality of image frames and playing times of the image frames

a second acquisition module configured to acquire a configuration file;

a generation module, configured to generate an animation file based on the plurality of image frames, the playing times of the image frames and the configuration file and play the animation file;

a third acquisition module, configured to acquire effect image frame(s) in a process of playing the animation file;

a control module, configured to control the effect image frame(s) to play based on a preset shooting parameter.

The embodiment of the present disclosure further provides an electronic device, including: a processor; a memory for storing instructions executable by the processor; wherein the processor is used for reading the executable instructions from the memory and executing the instructions to implement the animation effect generation method provided by the embodiment of the present disclosure.

The embodiment of the present disclosure also provides a non-transitory computer-readable storage medium, which stores a computer program for executing the animation effect generation method provided by the embodiment of the present disclosure.

The embodiment of the present disclosure also provides a computer program, comprising instructions which, when executed by a processor, cause the processor to execute the animation effect generation method provided by the embodiment of the present disclosure.

### BRIEF DESCRIPTION OF THE DRAWINGS

The above and other features, advantages, and aspects of embodiments of the present disclosure will become more apparent by referring to the following detailed description when taken in combination with the accompanying drawings. Throughout the drawings, the same or similar reference signs refer to the same or similar elements. It should be understood that the drawings are schematic and that the originals and elements are not necessarily drawn to scale.

FIG. 1 is a flow diagram of an animation effect generation method provided by an embodiment of the present disclosure;

FIG. 2 is a flow diagram of another animation effect generation method provided by an embodiment of the present disclosure;

FIG. 3 is a schematic diagram of two-dimensional images of a target object provided by an embodiment of the present disclosure;

FIG. 4 is a schematic diagram of an animation effect display image provided by an embodiment of the present disclosure;

FIG. 5 is a schematic diagram of another animation effect display image provided by an embodiment of the present disclosure;

FIG. 6 is a schematic structural diagram of an animation effect generation apparatus provided by an embodiment of the present disclosure;

FIG. 7 is a schematic structural diagram of an electronic device provided by an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be embodied in various forms and should not be construed as limited to the embodiments set forth herein, but rather these embodiments are provided for a more complete and thorough understanding of the present disclosure. It should be understood that the drawings and embodiments of the present disclosure are for illustration purposes only and are not intended to limit the scope of the present disclosure.

It should be understood that the various steps recited in the method embodiments of the present disclosure may be performed in a different order, and/or performed in parallel. Moreover, the method embodiments may include additional steps and/or omit performing the illustrated steps. The scope of the present disclosure is not limited in this respect.

The term “comprise” and variations thereof as used herein are intended to be open-ended, i.e., “comprise but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions for other terms will be given in the following description.

It should be noted that the terms “first”, “second”, and the like in the present disclosure are only used for distinguishing different devices, modules or units, and are not used for limiting the order of functions performed by the devices, modules or units or interdependence thereof.

It is noted that references to “a” or “a plurality of” mentioned in the present disclosure are intended to be illustrative rather than limiting, and those skilled in the art will appreciate that unless otherwise clearly indicated in the context, they should be understood as “one or more”.

The names of messages or information exchanged between devices in the embodiments of the present disclosure are for illustrative purposes only, and are not intended to limit the scope of the messages or information.

In the related art, users shoot a video through a terminal, and select effects material provided by the platform to fuse with the video to get the video with effects. However, this method cannot change configuration files such as background, and cannot freely adjust a foreground viewing angle, so it is not flexible enough.

In order to solve or at least partially solve the above technical problem, the present disclosure provides an animation specific effect generation method, apparatus, device and medium.

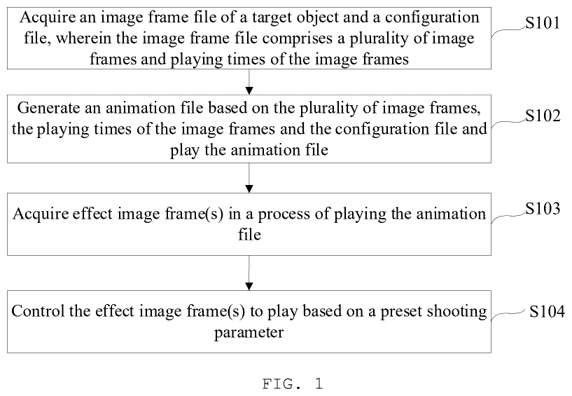

FIG. 1 is a flow diagram of an animation effect generation method provided by an embodiment of the present disclosure, which can be executed by an animation effect generation apparatus, wherein the apparatus can be implemented in at least one of software or hardware, and generally can be integrated in an electronic device. As shown in FIG. 1, the method includes steps 101 to 104.

In Step 101, an image frame file of a target object and a configuration file are acquired, wherein the image frame file comprises a plurality of image frames and playing times (playing timing) of the image frames.

The target object can be any object, and the embodiments of this disclosure does not limit the target object. For example, the target object can be a dancing person, a running animal or a bouncing ball. The image frame file includes a plurality of image frames and the playing times of the image frames. An image frame refers to an image including the target object, and a playing time of the image frame indicates a playing order of the image frame among the plurality of image frames, which can be a playing interval between a total playing time of all image frames and the image frame, or a playing duration corresponding to the image frame, that is, an interval between the playing time of the image frame and the playing time of the first frame in the plurality of image frames. The configuration file is a file for configuring animation background, animation audio, etc. For example, a background file can play the background in animation, and an audio file can play the audio in animation, depending on the application scene.

In the embodiments of the present disclosure, there are many ways to obtain the image frame file of the target object. In some embodiments, a plurality of color images are collected in a scene where the target object moves based on a preset motion trajectory, and depth image(s) and transparency image(s) corresponding to at least part of the color images; playing times of the color images are determined; and the image frame file is generated according to the plurality of color images, the depth image(s) and the transparency image(s) corresponding to the at least part of the color images, and the playing times of the color images.

In other embodiments, a target address is determined based on the target object. The color images, the depth image(s) and the transparency image(s) corresponding to the at least part of the color images and the playing times are downloaded from the target address to generate the image frame file. The above two ways are only examples of acquiring the image frame file of the target object, and the embodiments of the present disclosure do not specifically limit the way of acquiring the image frame file of the target object.

In the embodiment of the present disclosure, the acquiring the configuration file comprises: acquiring a configuration file such as at least one of a background file or an audio file based on a trigger operation on a preset configuration file selection control on an animation effect generation page by a user. The animation effect generation page is a page configured to generate animation effects, and the configuration file selection control is an anchor point set in the animation effect generation page for selecting the configuration file. The expression form of the configuration file selection control is not limited, for example, the configuration file selection control can be an icon or text information.

Specifically, in the process of animation effect generation, the user's trigger operation on the animation effect generation page can be detected, when the user's click operation or hover operation on the image frame file selection control is detected, the image frame file can be received, and when the user's click operation or hover operation on the configuration file selection control is detected, the configuration file can be received.

Step 102, an animation file is generated based on the plurality of image frames, the playing times of the image frames and the configuration file and the animation file is played.

A plurality of image frames refer to images that are continuous and form an animation in the order of playing times, wherein a playing time of the image frame refers to a playing duration of the image frame, so that an interval between two image frames can also be obtained.

In some embodiments of the present disclosure, the configuration file includes a background image frame and an audio file, and the generating the animation file based on the plurality of image frames, the playing times of the image frames and the configuration file and playing the animation file comprises: taking the plurality of image frames as foreground image frames, and fusing the foreground image frames with the background image to obtain animation image frames; and generating the animation file based on the playing time of the image frames, the audio file and the animation image frames and playing the animation file.

In other embodiments of the present disclosure, the configuration file includes a background image frame, and the generating the animation file based on the plurality of image frames, the playing times of the image frames and the configuration file and playing the animation file comprises: taking the plurality of image frames as foreground image frames, and fusing the foreground image frames with the background image to obtain animation image frames; and generating the animation file based on the playing time of the image frames and the animation image frames and playing the animation file.

Specifically, the plurality of image frames, the playing times of the image frames and the configuration file are fused to generate the animation file, and more specifically, the configuration file includes a background file and an audio file. When playing the animation file, the playing of the plurality of image frames, background and audio are controlled according to the playing times of the image frames, so that a video can be generated based on two-dimensional images and the configuration file and played, and the configuration file can be selected and reused as needed, further improving the generation efficiency of animation effects and reducing the generation cost of animation effects to meet the user's use requirements.

In the embodiment of the present disclosure, after acquiring the image frame file and the configuration file of the target object, the animation file can be generated based on the plurality of image frames, the playing times of the image frames and the configuration file and played.

Step 103, effect image frame(s) are acquired in a process of playing the animation file.

Step 104, the effect image frame(s) are controlled to play based on a preset shooting parameter.

An effect image frame refers to any one of the plurality of image frames. The shooting parameter is configured to control the effect image frame(s) to move according to a certain motion trajectory.

The shooting parameter can be set before the effect image frame(s) is played, and can be set manually or automatically by programs or devices. According to the needs, other settings can also be adopted, which will not be described here.

In the embodiments of the present disclosure, there are many ways to obtain the effect image frame(s) in the process of playing an animation file. In some embodiments, in the process of playing the animation file, a currently playing image frame of the animation file is acquired in response to receiving an effect input operation; the currently playing image frame is matched with the plurality of image frames to obtain a key image frame; the effect image frame(s) are determined from the plurality of image frames based on the key image frame and a preset number of image frames. In other embodiments, in the process of playing an animation file, in response to detecting a matching image frame satisfying a preset effect condition, the effect image frame(s) are determined from the plurality of image frames based on the matching image frame and a preset number of image frames.

The above two ways are only examples of acquiring the effect image frame(s) in the process of playing the animation file, and the embodiments of the present disclosure does not specifically limit the way of acquiring the effect image frame(s) in the process of playing an animation file.

The number of image frames may be set before the step of determining the effect image frame(s) from the plurality of image frames, which can be set manually or automatically by programs or devices. According to the needs, other settings can also be adopted, which will not be described here.

In the embodiments of the present disclosure, the number of the effect image frame(s) can be one or more, and controlling the effect image frame(s) to play based on preset shooting parameters can be understood as controlling the effect image frame(s) to move according to a certain motion trajectory, for example, the effect image frame(s) rotates 360 degrees around the horizontal axis.

It should be noted that, in the animation effect generation method of the embodiment of the present disclosure, the animation in the time dimension is also supported to be played simultaneously. For example, while the foreground (such as a person) supports manual interaction, it can have its own animation, such as skirt fluttering. That is to say, the solution of the embodiment of the present disclosure can support animation effects with higher definition and more flexible viewing angle or trajectory, and can also support timeline animation.

The animation effect generation solution provided by the embodiments of the present disclosure comprises: acquiring an image frame file of a target object and a configuration file, wherein the image frame file comprises a plurality of image frames and playing times of the image frames; generating an animation file based on the plurality of image frames, the playing times of the image frames and the configuration file and playing the animation file; acquiring effect image frame(s) in a process of playing the animation file; controlling the effect image frame(s) to play based on a preset shooting parameter. By adopting the technical solution, any image frame can be controlled to move according to a certain motion trajectory in the animation playing process, and the animation effects are improved; moreover, animation is generated and played based on two-dimensional pictures and the configuration file, which reduces the animation generation cost and improves the animation generation efficiency, and further improves the display effect of effects in the animation scene.

In some embodiments, the acquiring the effect image frame(s) in the process of playing the animation file comprises: in the process of playing the animation file, acquiring a currently playing image frame of the animation file in response to receiving an effect input operation; matching the currently playing image frame with the plurality of image frames to obtain a key image frame; and determining the effect image frame(s) from the plurality of image frames based on the key image frame and a preset number of image frames.

The effect input operation is a user's interactive operation, that is, in the animation playing process, the user can interact manually to meet the need of viewing at any angle. The currently playing image frame is an image frame being played at the time point when the effect input operation is received. The preset number of image frames can be selected and set according to the needs of application scene, and can be one or more.

Specifically, when the user adjusts the viewing angle of the picture, for example, from left to viewing angle A, the picture seen is the same as that from right to viewing angle A. Therefore, it is possible to support, for example, the wind blowing the skirt, while the user controls the foreground (person) to rotate 360 degrees.

Specifically, the currently playing image frame includes a background part, so the currently playing image frame is matched with the plurality of image frames to obtain the key image frame, that is, the currently playing foreground image frame can be obtained as a key image frame, so that one or more image frames that are subsequently played in the key image frame can be obtained as the effect image frame(s) according to the preset number of image frames.

In the above solution, effect image frame(s) for rotation can be selected based on user interaction, so as to satisfy the user's viewing at any angle, and further improve the display effect of animation effects and the user's operation requirements.

In some embodiments, the acquiring the effect image frame(s) in the process of playing the animation file comprises: in the process of playing the animation file, in response to detecting a matching image frame satisfying a preset effect condition, determining the effect image frame(s) from the plurality of image frames based on the matching image frame and a preset number of image frames.

The preset effect condition can be set according to the needs of the application scene, such as meeting a preset playing time point, or taking the Nth image among a plurality of image frames in which the target object meets a preset posture as a matching image frame, where Nis a positive integer greater than or equal to 1.

Specifically, in the process of playing an animation file, when playing the target image frame, one or more image frames that are subsequently played in the key image frame are obtained as the effect image frame(s) according to the preset number of image frames.

In the above solution, the effect image frame(s) for rotation can be automatically selected during the animation playing process, so as to meet the user's need of viewing at any angle, and further improve the display effect of animation effects.

In some embodiments, collecting a plurality of color images in a scene where the target object moves based on a preset motion trajectory, and depth image(s) and transparency image(s) corresponding to at least part of the color images; the playing times of the color images are determined; the image frame file is generated according to the plurality of color images, the depth image(s) and the transparency image(s) corresponding to the at least part of the color images, and the playing times of the color images.

The color images refer to RGB (Red, Green and Blue) images. A gray value of each pixel of the depth image is used to indicate a distance between a certain point in the scene and an acquisition device. A transparency of the color image can be changed by setting a value of the target channel in the color image, and the transparency image refers to a color image whose target channel is set with a specific value.

In the embodiments of the present disclosure, a camera array or other devices with a function of collecting depth information can be used to shoot and collect images of the target object, or a video can be shot of the target object, and a plurality of frames of images can be selected from the video as an image frame file. The preset motion trajectory can be set according to the needs of the application scene, and color images in the motion scene based on different motion trajectories can be understood as the images corresponding to the target object at different angles, so that the image frame file obtained subsequently has better effects, and finally the animation effects are better.

In some embodiments, the generating the image frame file according to the plurality of color images, the depth image(s) and the transparency image(s) corresponding to the at least part of the color images, and the playing times of the color images comprises: encoding each of the color images, a depth image and a transparency image corresponding to each of the at least part of the color images respectively, and the playing times of the color images to obtain an encoded file; and decoding the encoded file to obtain the image frame file.

In the embodiment of the present disclosure, the encoded file obtained by respectively encoding the color images, the depth image(s) and transparency image(s) corresponding to the at least part of the color images, and the playing times of the color images can meet the requirements of high compression ratio, and the image frame file obtained by decoding the encoded file can meet the requirements of real-time animation effects. That is, for example, after encoding and decoding each of the color images, the depth image and transparency image corresponding to each color image, and the playing times of the color images, the display efficiency of the subsequent animation effects is further improved, and the display efficiency and effect requirements in animation effects scenes are further met. Encoding and decoding methods correspond, for example, one or more of fractal coding and decoding, model coding and decoding can be selected.

In the above solution, the image frame file is generated according to the plurality of color images, the depth image(s) and the transparency image(s) corresponding to the at least part of the color images, and the playing times of the color images, and encoding and decoding processing are performed, thus further improving the display efficiency and effect of animation effects.

In some embodiments, the configuration file includes a background image frame, and the generating the animation file based on the plurality of image frames, the playing times of the image frames and the configuration file and playing the animation file comprises: taking the plurality of image frames as foreground image frames, and fusing the foreground image frames with the background image to obtain animation image frames; and generating the animation file based on the playing time of the image frames and the animation image frames and playing the animation file.

The configuration file includes background image frame(s), which can be one or more. By using a plurality of image frames as foreground image frames and fusing them with background image frame(s), animation image frames including foreground and background can be obtained, and an animation file can be further generated and played based on the playing times of the image frames and the animation image frames.

In the above solution, an animation with the target object as the foreground is generated and played, and effects processing such as rotating the foreground (target objects such as people and animals) while playing the animation image frames, further improving the display effect of animation effects and meeting the user's operation requirements.

In some embodiments, the animation effect generation method may further comprise: receiving a configuration update request comprising a new configuration file; the generating the animation file based on the plurality of image frames, the playing times of the image frames and the configuration file and playing the animation file comprises: generating a new animation file based on the new configuration file, the playing time of the image frames and the image frame file and playing the new animation file.

The new configuration file refers to a new background file, a new audio file, etc., so that a new animation file is generated based on the new configuration file and the image frame file and played.

In the above solution, the configuration file can be changed at any time and can be reused, further reducing the production cost of animation effects and improving the production efficiency of animation effects.

In some embodiments, the configuration file includes an audio file, and after controlling the effect image frame(s) to play based on preset shooting parameters, the method further comprises: detecting whether a currently playing image frame corresponds to a preset audio time point; acquiring a target audio point corresponding to the currently playing image frame in response to the currently playing image frame not corresponding to the preset audio time point, and synchronously playing the currently playing image frame and audio file at the target audio point.

In the embodiments of the present disclosure, one axis is used as a time axis, and the other axis is used as a free view trajectory progress axis, and the picture is synchronized with the audio data based on the time axis.

Specifically, in a two-dimensional video scene, as long as the time axis of one dimension is aligned, the synchronization problem of audio and picture can be solved. For example, when the audio and the picture are not synchronized, it is necessary to pull the state back to the synchronization of the audio and the picture, such as quickly adjusting the picture to the time point corresponding to the sound. Similarly, in a two-dimensional video scene, it is assumed that the time axis is T and the trajectory progress axis is P. The current sound is at T1 point on the time axis, and the picture is at (T0, P0) point, where T0 corresponds to the time axis and P0 corresponds to the trajectory progress axis, then the audio and picture synchronization solution is to quickly locate the picture to (T1, P0) point.

It should be noted that the time axis is usually long, and when the encoding and decoding solution is customized at the server, playing and decoding can be performed simultaneously, further improving the effect and efficiency of effects animation.

In the above solution, the audio and pictures are synchronized in real time to ensure the effect of the effects animation and meet the user's use requirements.

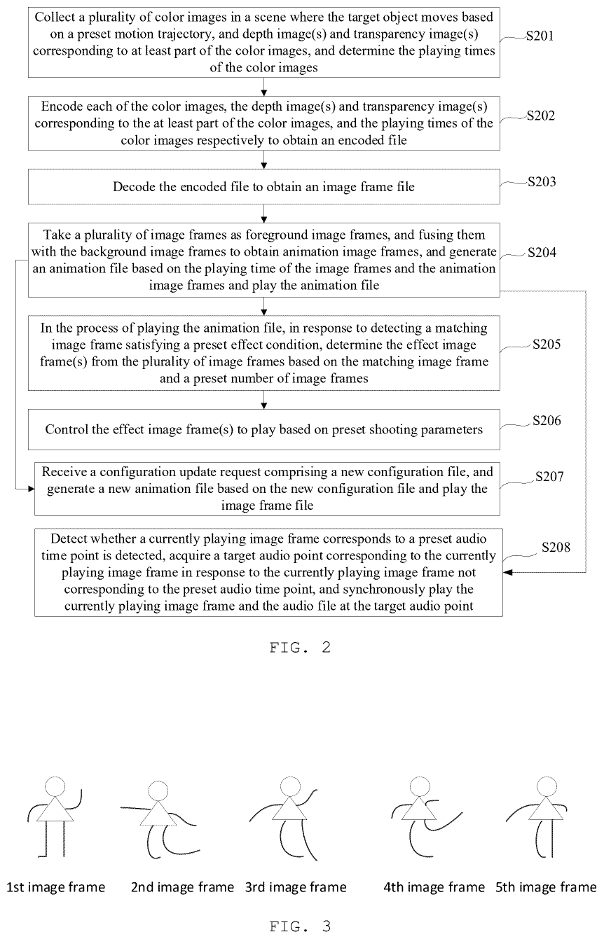

FIG. 2 is a flow diagram of another animation effect generation method provided by an embodiment of the present disclosure. This embodiment further optimizes the animation effect generation method on the basis of the above embodiment. As shown in FIG. 2, the method includes steps 201 to 208.

In Step 201, a plurality of color images in a scene where the target object moves based on a preset motion trajectory, and depth image(s) and transparency image(s) corresponding to at least part of the color images are collected, and the playing times of the color images are determined.

In Step 202, each of the color images, the depth image(s) and transparency image(s) corresponding to the at least part of the color images, and the playing times of the color images are respectively encoded to obtain an encoded file.

In Step 203, the encoded file is decoded to obtain an image frame file.

In the embodiments of the present disclosure, five-dimensional data collection is supported, and the five-dimensional data includes RGB color, scene depth and transparency. A comprehensive acquisition solution of multi-algorithm and multi-scene fusion is supported, such as camera array, unmanned aerial vehicle, offline rendering, etc. In an offline rendering scene, the foreground and background, depth and transparent scene material information are all known. In camera array, unmanned aerial vehicle and other physical scenes, the solution integrates the algorithms of foreground and background separation, depth estimation and transparency, and realizes five-dimensional data acquisition.

In the embodiments of the present disclosure, each of the color images, the depth image(s) and transparency image(s) corresponding to the each color image, and the playing times of the color image are encoded to obtain an encoded file, and the encoded file is decoded to obtain an image frame file. On the basis of traditional streaming media decoding, random access decoding during single frame surround view is integrated to meet the requirements of real-time rendering, that is, a streaming media playing solution is adopted while compressing, which realizes playing while pulling the media stream.

For example, FIG. 3 is a schematic diagram of two-dimensional images of a target object provided by an embodiment of the present disclosure, which shows a schematic diagram of two-dimensional images (the first to fifth image frames) corresponding to a target object, namely, a person. The two-dimensional images include two-dimensional images of the target object at different viewing angles, including color images and depth image(s) and transparency image(s) corresponding to the color images. The above is just an example. In order to improve the subsequent effects, two-dimensional images of the target object at multiple different viewing angles can be collected.

In Step 204, a plurality of image frames are taken as foreground image frames, and fused with the background image frames to obtain animation image frames, and an animation file is generated based on the playing time of the image frames and the animation image frames and played.

After step 204, steps 205 to 206 and/or step 207 and/or step 208 can be executed, and the execution order of steps 204 to 208 can be determined according to the actual situation, and FIG. 2 is only an example.

In Step 205, in the process of playing the animation file, in response to detecting a matching image frame satisfying a preset effect condition, the effect image frame(s) are determined from the plurality of image frames based on the matching image frame and a preset number of image frames.

In Step 206, the effect image frame(s) are controlled to play based on preset shooting parameters.

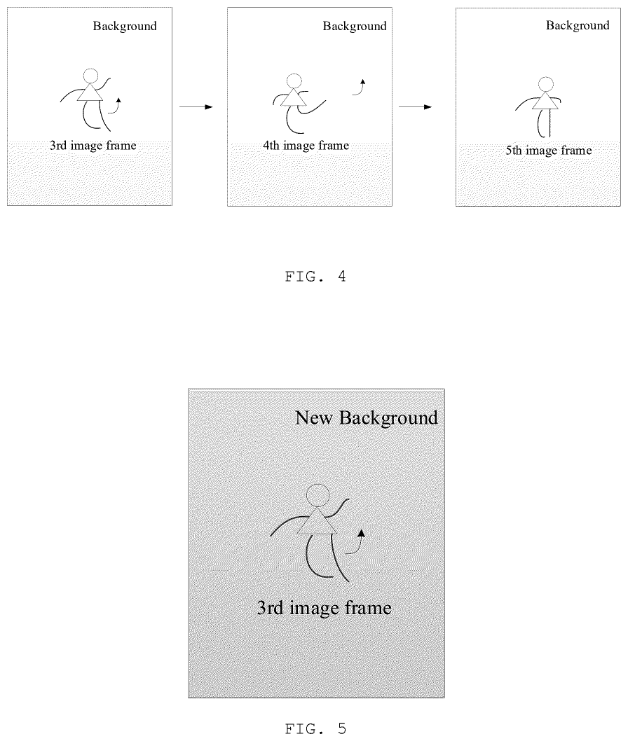

For example, FIG. 4 is a schematic diagram of an animation effect display image provided by an embodiment of the present disclosure. FIG. 4 shows that the third frame is a matching image frame meeting a preset posture, and a fourth image frame and a fifth image frame are obtained as effect image frames, so that the fourth image frame and the fifth image frame are controlled to move according to a preset motion trajectory, that is, the animation effect rotation direction of the foreground (person) is realized. FIG. 4 is only an example of the rotation angle, and different effects can be performed on the foreground (person) based on different angles.

In Step 207, a configuration update request comprising a new configuration file is received, and a new animation file is generated based on the new configuration file and the image frame file and played.

For example, FIG. 5 is a schematic diagram of another animation effect display image provided by an embodiment of the present disclosure. FIG. 5 shows that the animation file is updated in real time with the update of the configuration file, that is, different animation playing effects can be realized based on different configuration files, which further meets the user's use requirements and improves the user's use experience.

In Step 208, whether a currently playing image frame corresponds to a preset audio time point is detected, a target audio point is acquired corresponding to the currently playing image frame in response to the currently playing image frame not corresponding to the preset audio time point, and the currently playing image frame and the audio file are synchronously played at the target audio point.

Therefore, the construction, design and re-rendering of three-dimensional scenes can be realized, such as changing the background, adding interactive effects, adding intra-frame music, etc., thus realizing interactive media playback.

The animation effect generation solution provided by the embodiment of the present disclosure comprises: collecting a plurality of color images in a scene where the target object moves based on a preset motion trajectory, and depth image(s) and transparency image(s) corresponding to at least part of the color images, and determining the playing times of the color images; encoding each of the color images, a depth image and a transparency image corresponding to each of the at least part of the color images respectively, and the playing times of the color images to obtain an encoded file; decoding the encoded file to obtain the image frame file; generating an animation file based on the plurality of image frames, the playing time of the image frames and the configuration file and playing the animation file; in the process of playing the animation file, in response to detecting a matching image frame satisfying a preset effect condition, determining the effect image frame(s) from the plurality of image frames based on the matching image frame and a preset number of image frames, and controlling the effect image frame(s) to play based on preset shooting parameters; receiving a configuration update request comprising a new configuration file, and generating a new animation file based on the new configuration file and the image frame file and playing the new animation file; detecting whether a currently playing image frame corresponds to a preset audio time point after the controlling the effect image frame(s) to play based on the preset shooting parameter, acquiring a target audio point corresponding to the currently playing image frame in response to the currently playing image frame not corresponding to the preset audio time point; synchronously playing the currently playing image frame and audio file at the target audio point. By adopting the technical solution, any image frame can be controlled to move according to a certain motion trajectory in the animation playing process, and the animation effects are improved; moreover, animation is generated and played based on two-dimensional pictures and the configuration file, which reduces the animation generation cost and improves the animation generation efficiency, and further improves the display effect of the effects in the animation scene. Moreover, the configuration file can be updated at any time and reused, which further improves the production effect of effects and reduces the production cost, and realizes the synchronization of audio and pictures, thus further improving the effects in the animation effects scene.

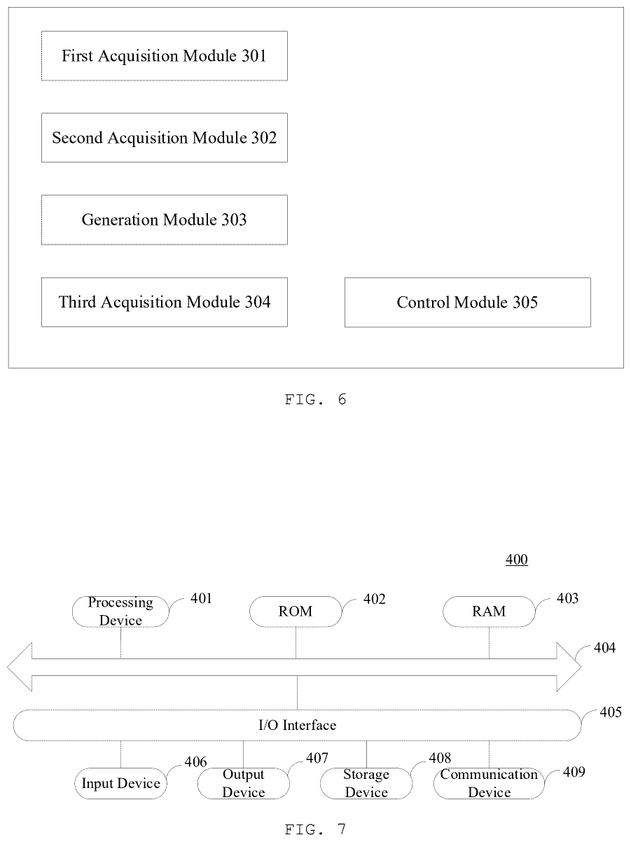

FIG. 6 is a schematic structural diagram of an animation effect generation apparatus provided by an embodiment of the present disclosure, which can be implemented in at least one of software or hardware, and generally can be integrated in an electronic device. As shown in FIG. 6, the apparatus comprises:

a first acquisition module 301, configured to acquire an image frame file of a target object, wherein the image frame file comprises a plurality of image frames and playing times of the image frames;

a second acquisition module 302, configured to acquire a configuration file;

a generation module 303, configured to generate an animation file based on the plurality of image frames, the playing times of the image frames and the configuration file and play the animation file;

a third acquisition module 304, configured to acquire effect image frame(s) in a process of playing the animation file;

a control module 305, configured to control the effect image frame(s) to play based on a preset shooting parameter.

Optionally, the third acquisition module 304 is specifically configured to:

in the process of playing the animation file, acquire a currently playing image frame of the animation file in response to receiving an effect input operation;

match the currently playing image frame with the plurality of image frames to obtain a key image frame;

determine the effect image frame(s) from the plurality of image frames based on the key image frame and a preset number of image frames.

Optionally, the third acquisition module 304 is specifically configured to:

in the process of playing the animation file, in response to detecting a matching image frame satisfying a preset effect condition, determine the effect image frame(s) from the plurality of image frames based on the matching image frame and a preset number of image frames.

Optionally, the first acquisition module 301 comprises:

a collection unit, configured to collect a plurality of color images in a scene where the target object moves based on a preset motion trajectory, and depth image(s) and transparency image(s) corresponding to at least part of the color images;

a determination unit, configured to determine playing times of the color images;

a generation unit, configured to generate the image frame file according to the plurality of color images, the depth image(s) and the transparency image(s) corresponding to the at least part of the color images, and the playing times of the color images.

Optionally, the generation unit is specifically configured to:

encode each of the color images, a depth image and a transparency image corresponding to each of the at least part of the color images respectively, and the playing times of the color images to obtain an encoded file;

decode the encoded file to obtain the image frame file.

Optionally, the configuration file includes a background image frame, and the generation module 303 is specifically configured to:

take the plurality of image frames as foreground image frames, and fusing the foreground image frames with the background image to obtain animation image frames;

generate the animation file based on the playing time of the image frames and the animation image frames and playing the animation file.

Optionally, the apparatus further comprises a receiving module configured to:

receive a configuration update request comprising a new configuration file; the generation module 303 is specifically configured to:

generate a new animation file based on the new configuration file, the playing times of the image frames and the image frame file and playing the new animation file.

Optionally, the apparatus further comprises:

a detection module, configured to detect whether a currently playing image frame corresponds to a preset audio time point after the controlling the effect image frame(s) to play based on the preset shooting parameter;

a fourth acquisition module, configured to acquire a target audio point corresponding to the currently playing image frame in response to the currently playing image frame not corresponding to the preset audio time point;

a synchronization module, configured to synchronously play the currently playing image frame and audio file at the target audio point.

The animation effect generation apparatus provided by the embodiment of the present disclosure can execute the animation effect generation method provided by any embodiment of the present disclosure, and has corresponding functional modules and beneficial effects.

The embodiment of the present disclosure also provides a computer program product comprising a computer program/instructions, which when executed by a processor, implement the animation effect generation method provided by any embodiment of the present disclosure.

FIG. 7 is a schematic structural diagram of an electronic device provided by an embodiment of the present disclosure. Referring now specifically to FIG. 7, which shows a schematic structural diagram suitable for implementing an electronic device 400 in an embodiment of the present disclosure. The terminal device 400 in the embodiment of the present disclosure may include, but is not limited to, a mobile terminal such as a mobile phone, a notebook computer, a digital broadcast receiver, a PDA (personal digital assistant), a PAD (tablet), a PMP (portable multimedia player), a vehicle terminal (e.g., a car navigation terminal), and etc., and a fixed terminal such as a digital TV, a desktop computer, and etc. The electronic device shown in FIG. 7 is only an example, and should not bring any limitation to the functions and the scope of the application of the embodiments of the present disclosure.

As shown in FIG. 7, the terminal device 400 may include a processing device (e.g., a central processer, a graphics processor, etc.) 401 that may perform various appropriate actions and processes according to a program stored in a read-only memory (ROM) 402 or a program loaded from a storage device 408 into a random access memory (RAM) 403. In the RAM 403, various programs and data necessary for the operation of the electronic device 400 are also stored. The processing device 401, the ROM 1002, and the RAM 403 are connected to each other via a bus 404. An input/output (I/O) interface 405 is also connected to the bus 404.

Generally, the following devices can be connected to the I/O interface 405: an input device 406 including, for example, a touch screen, touch pad, keyboard, mouse, camera, microphone, accelerometer, gyroscope, etc.; an output device 407 including, for example, a Liquid Crystal Display (LCD), speaker, vibrator, etc.; a storage device 408 including, for example, magnetic tape, hard disk, etc.; and a communication device 409. The communication device 409 may allow the electronic device 400 to communicate with other devices wirelessly or by wire to exchange data. While FIG. 7 illustrates an electronic device 400 having various means, it is to be understood that it is not required to implement or provide all of the means shown. More or fewer means may be alternatively implemented or provided.

In particular, the processes described above with reference to the flow diagrams may be implemented as computer software programs, according to the embodiments of the present disclosure. For example, an embodiment of the present disclosure includes a computer program product comprising a computer program carried on a non-transitory computer readable medium, the computer program containing program code for performing the method illustrated by the flow diagram. In such an embodiment, the computer program may be downloaded and installed from the network via the communication device 409, or installed from the storage device 408, or installed from the ROM 402. When executed by the processing device 401, the computer program performs the above-described functions defined in the animation effect generation method of the embodiments of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in combination with an instruction execution system, apparatus, or device. In contrast, in the present disclosure, a computer readable signal medium may include a data signal propagated in a baseband or as a part of a carrier wave, wherein a computer readable program code is carried therein. Such a propagated data signal may take a variety of forms, including, but not limited to, an electro-magnetic signal, an optical signal, or any suitable combination thereof. A computer-readable signal medium may be any computer readable medium other than a computer-readable storage medium and the computer-readable signal medium can communicate, propagate, or transport a program for use by or in combination with an instruction execution system, apparatus, or device. Program code embodied on a computer-readable medium may be transmitted using any appropriate medium, including but not limited to: electrical wires, optical cables, RF (radio frequency), etc., or any suitable combination thereof.

In some embodiments, the client and the server can communicate using any currently known or future-developed network protocol, such as HTTP (HyperText Transfer Protocol), and may be interconnected to digital data communication (e.g., a communication network) of any form or medium. Examples of communication networks include a local area network (“LAN”), a wide area network (“WAN”), the Internet (e.g., the Internet), and a peer-to-peer network (e.g., ad hoc peer-to-peer network), as well as any currently known or future developed network.

The computer readable medium may be included in the above-mentioned electronic device; or it may exist alone without being assembled into the electronic device.

The computer-readable medium carries one or more programs, and when the one or more programs are executed by the electronic device, the electronic device is enabled to: receive a user's information display trigger operation during the video playing process; acquire at least two target information associated with the video; display a first target information of the at least two target information in an information display area of a playing page of the video, wherein the size of the information display area is smaller than that of the playing page; receive a first switching trigger operation of the user, and switch the first target information displayed in the information display area to a second target information among the at least two target information.

Computer program code for carrying out operations of the present disclosure may be written in one or more programming languages or a combination thereof, the programming languages include, but are not limited to an object oriented programming language such as Java, Smalltalk, C++, and also include conventional procedural programming languages, such as the “C” programming language, or similar programming languages. The program code can be executed entirely on the user's computer, partly on the user's computer, as an independent software package, partly on the user's computer and partly executed on a remote computer, or entirely on the remote computer or server. In the scenario involving a remote computer, the remote computer may be connected to the user's computer through any type of network, including a Local Area Network (LAN) or a Wide Area Network (WAN), or may be connected to an external computer (for example, through the Internet using an Internet service provider).

The flow diagrams and block diagrams in the figures illustrate the architecture, functionality, and operation that are possibly implemented by systems, methods and computer program products according to various embodiments of the present disclosure. In this regard, each block in the flow diagrams or block diagrams may represent a module, program segment, or portion of code, which comprises one or more executable instructions for implementing the specified logical function(s). It should also be noted that, in some alternative implementations, the functions noted in the blocks may occur in an order different from that noted in the figures. For example, two blocks shown in succession may, in fact, be executed substantially concurrently, or they may sometimes be executed in a reverse order, depending upon the function involved. It will also be noted that each block of the block diagrams and/or flow diagrams, and a combination of blocks in the block diagrams and/or flow diagrams, can be implemented by special purpose hardware-based systems that perform the specified functions or operations, or combinations of special purpose hardware and computer instructions.

The units described in the embodiments of the present disclosure may be implemented by software or hardware. Wherein the name of a unit does not in some cases constitute a limitation on the unit itself.

The functions described herein above may be performed, at least in part by one or more hardware logic components. For example, without limitation, exemplary types of hardware logic components that may be used include Field Programmable Gate Arrays (FPGAs), Application Specific Integrated Circuits (ASICs), Application Specific Standard Products (ASSPs), Systems on a Chip (SOCs), Complex Programmable Logic Devices (CPLDs), and so forth.

In the context of this disclosure, a machine readable medium may be a tangible medium that can contain, or store a program for use by or in combination with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination thereof. More specific examples of the machine readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, the present disclosure provides an animation effect generation method, comprising:

acquiring an image frame file of a target object and a configuration file, wherein the image frame file comprises a plurality of image frames and playing times of the image frames;

generating an animation file based on the plurality of image frames, the playing times of the image frames and the configuration file and playing the animation file;

acquiring effect image frame(s) in a process of playing the animation file; and

controlling the effect image frame(s) to play based on a preset shooting parameter.

According to one or more embodiments of the present disclosure, in the animation effect generation method provided by the present disclosure, the acquiring the effect image frame(s) in the process of playing the animation file comprises:

in the process of playing the animation file, acquiring a currently playing image frame of the animation file in response to receiving an effect input operation;

matching the currently playing image frame with the plurality of image frames to obtain a key image frame; and

determining the effect image frame(s) from the plurality of image frames based on the key image frame and a preset number of image frames.

According to one or more embodiments of the present disclosure, in the animation effect generation method provided by the present disclosure, the acquiring the effect image frame(s) in the process of playing the animation file comprises:

in the process of playing the animation file, in response to detecting a matching image frame satisfying a preset effect condition, determining the effect image frame(s) from the plurality of image frames based on the matching image frame and a preset number of image frames.

According to one or more embodiments of the present disclosure, in the animation effect generation method provided by the present disclosure, acquiring the image frame file of the target object comprises:

collecting a plurality of color images in a scene where the target object moves based on a preset motion trajectory, and depth image(s) and transparency image(s) corresponding to at least part of the color images;

determining playing times of the color images; and

generating the image frame file according to the plurality of color images, the depth image(s) and the transparency image(s) corresponding to the at least part of the color images, and the playing times of the color images.

According to one or more embodiments of the present disclosure, in the animation effect generation method provided by the present disclosure, the generating the image frame file according to the plurality of color images, the depth image(s) and the transparency image(s) corresponding to the at least part of the color images, and the playing times of the color images comprises:

encoding each of the color images, a depth image and a transparency image corresponding to each of the at least part of the color images respectively, and the playing times of the color images to obtain an encoded file; and

decoding the encoded file to obtain the image frame file.

According to one or more embodiments of the present disclosure, in the animation effect generation method provided by the present disclosure, the configuration file comprises a background image frame, and the generating the animation file based on the plurality of image frames, the playing times of the image frames and the configuration file and playing the animation file comprises:

taking the plurality of image frames as foreground image frames, and fusing the foreground image frames with the background image to obtain animation image frames; and

generating the animation file based on the playing time of the image frames and the animation image frames and playing the animation file.

According to one or more embodiments of the present disclosure, the animation effect generation method provided by the present disclosure further comprises:

receiving a configuration update request comprising a new configuration file;

the generating the animation file based on the plurality of image frames, the playing times of the image frames and the configuration file and playing the animation file comprises:

generating a new animation file based on the new configuration file, the playing times of the image frames and the image frame file and playing the new animation file.

According to one or more embodiments of the present disclosure, in the animation effect generation method provided by the present disclosure, the configuration file comprises an audio file, and the animation effect generation method further comprises:

detecting whether a currently playing image frame corresponds to a preset audio time point after the controlling the effect image frame(s) to play based on the preset shooting parameter;

acquiring a target audio point corresponding to the currently playing image frame in response to the currently playing image frame not corresponding to the preset audio time point; and

synchronously playing the currently playing image frame and audio file at the target audio point.

According to one or more embodiments of the present disclosure, the present disclosure provides an animation effect generation apparatus, comprising:

a first acquisition module, configured to acquire an image frame file of a target object, wherein the image frame file comprises a plurality of image frames and playing times of the image frames (e.g., a play time of each of the image frames);

a second acquisition module, configured to acquire a configuration file;

a generation module, configured to generate an animation file based on the plurality of image frames, the playing times of the image frames and the configuration file and play the animation file;

a third acquisition module, configured to acquire effect image frame(s) in a process of playing the animation file;

a control module, configured to control the effect image frame(s) to play based on a preset shooting parameter.

According to one or more embodiments of the present disclosure, in the animation effect generation apparatus provided by the present disclosure, the third acquisition module is specifically configured to:

in the process of playing the animation file, acquire a currently playing image frame of the animation file in response to receiving an effect input operation;

match the currently playing image frame with the plurality of image frames to obtain a key image frame; and

determine the effect image frame(s) from the plurality of image frames based on the key image frame and a preset number of image frames.

According to one or more embodiments of the present disclosure, in the animation effect generation apparatus provided by the present disclosure, the third acquisition module is specifically configured to:

in the process of playing the animation file, in response to detecting a matching image frame satisfying a preset effect condition, determine the effect image frame(s) from the plurality of image frames based on the matching image frame and a preset number of image frames.

According to one or more embodiments of the present disclosure, in the animation effect generation apparatus provided by the present disclosure, the first acquisition module 301 comprises:

a collection unit, configured to collect a plurality of color images in a scene where the target object moves based on a preset motion trajectory, and depth image(s) and transparency image(s) corresponding to at least part of the color images;

a determination unit, configured to determine playing times of the color images;

a generation unit, configured to generate the image frame file according to the plurality of color images, the depth image(s) and the transparency image(s) corresponding to the at least part of the color images, and the playing times of the color images.

According to one or more embodiments of the present disclosure, in the animation effect generation apparatus provided by the present disclosure, the generation unit is specifically configured to:

encode each of the color images, a depth image and a transparency image corresponding to each of the at least part of the color images respectively, and the playing times of the color images to obtain an encoded file; and decode the encoded file to obtain the image frame file.

According to one or more embodiments of the present disclosure, in the animation effect generation apparatus provided by the present disclosure, the configuration file comprises a background image frame, and the generation module 303 is specifically configured to:

take the plurality of image frames as foreground image frames, and fusing the foreground image frames with the background image to obtain animation image frames; and

generate the animation file based on the playing time of the image frames and the animation image frames and playing the animation file.

According to one or more embodiments of the present disclosure, in the animation effect generation apparatus provided by the present disclosure, the apparatus further comprises a receiving module configured to:

receive a configuration update request comprising a new configuration file; the generation module 303 is specifically configured to:

generate a new animation file based on the new configuration file, the playing times of the image frames and the image frame file and playing the new animation file.

According to one or more embodiments of the present disclosure, in the animation effect generation apparatus provided by the present disclosure, the apparatus further comprises:

a detection module, configured to detect whether a currently playing image frame corresponds to a preset audio time point after the controlling the effect image frame(s) to play based on the preset shooting parameter;

a fourth acquisition module, configured to acquire a target audio point corresponding to the currently playing image frame in response to the currently playing image frame not corresponding to the preset audio time point; and

a synchronization module, configured to synchronously play the currently playing image frame and audio file at the target audio point.

According to one or more embodiments of the present disclosure, the present disclosure provides an electronic device comprising:

a processor;

a memory for storing instructions executable by the processor;

the processor being used for reading the executable instructions from the memory and executing the instructions to implement any one of the animation effect generation methods provided by the present disclosure.

According to one or more embodiments of the present disclosure, the present disclosure provides a non-transitory computer-readable storage medium, which stores a computer program used for executing any one of the animation effect generation methods provided by the present disclosure.

According to one or more embodiments of the present disclosure, the present disclosure provides a computer program, including instructions that, when executed by a processor, cause the processor to execute the animation effect generation method provided by the embodiments of the present disclosure.

The above descriptions are only preferred embodiments of the present disclosure and are illustrative of the principles of the technology employed. It will be appreciated by those skilled in the art that the scope of disclosure of the present disclosure is not limited to the technical solutions formed by specific combinations of the above-described technical features, and should also encompass other technical solutions formed by any combination of the above-described technical features or equivalents thereof without departing from the concept of the present disclosure. For example, the technical solutions formed by the above features be replaced with (but not limited to) features having similar functions disclosed in the present disclosure.

Further, although operations are depicted in a particular order, this should not be understood as requiring such operations to be performed in the particular order shown or in sequential order. Under certain circumstances, multitasking and parallel processing may be advantageous. Likewise, although several specific implementation details are included in the above discussion, these should not be construed as limitations on the scope of the present disclosure. Certain features that are described in the context of a single embodiment can also be implemented in combination in the single embodiment. Conversely, various features that are described in the context of a single embodiment can also be implemented in multiple embodiments separately or in any suitable subcombination.

Although the present subject matter has been described in language specific to structural features and/or methodological acts, it is to be understood that the subject matter defined in the appended claims is not necessarily limited to the specific features or acts described above.

1. An animation effect generation method, comprising:
acquiring an image frame file of a target object and a configuration file, wherein the image frame file comprises a plurality of image frames and a play time of each of the image frames;
generating an animation file based on the plurality of image frames, the play time of each of the image frames and the configuration file and playing the animation file;
acquiring effect image frame(s) in a process of playing the animation file; and
controlling the effect image frame(s) to play based on a preset shooting parameter.

2. The animation effect generation method according to claim 1, wherein the acquiring the effect image frame(s) in the process of playing the animation file comprises:
in the process of playing the animation file, acquiring a currently playing image frame of the animation file in response to receiving an effect input operation;
matching the currently playing image frame with the plurality of image frames to obtain a key image frame; and
determining the effect image frame(s) from the plurality of image frames based on the key image frame and a preset number of image frames.

3. The animation effect generation method according to claim 1, wherein the acquiring the effect image frame(s) in the process of playing the animation file comprises:
in the process of playing the animation file, in response to detecting a matching image frame satisfying a preset effect condition, determining the effect image frame(s) from the plurality of image frames based on the matching image frame and a preset number of image frames.

4. The animation effect generation method according to claim 1, wherein acquiring the image frame file of the target object comprises:
collecting a plurality of color images in a scene where the target object moves based on a preset motion trajectory, and depth image(s) and transparency image(s) corresponding to at least part of the color images;
determining playing times of the color images; and
generating the image frame file according to the plurality of color images, the depth image(s) and the transparency image(s) corresponding to the at least part of the color images, and the playing times of the color images.

5. The animation effect generation method according to claim 4, wherein the generating the image frame file according to the plurality of color images, the depth image(s) and the transparency image(s) corresponding to the at least part of the color images, and the playing times of the color images comprises:
encoding each of the color images, a depth image and a transparency image corresponding to each of the at least part of the color images respectively, and the playing times of the color images to obtain an encoded file; and
decoding the encoded file to obtain the image frame file.

6. The animation effect generation method according to claim 1, wherein the configuration file comprises a background image frame, and the generating the animation file based on the plurality of image frames, the play time of each of the image frames and the configuration file and playing the animation file comprises:
taking the plurality of image frames as foreground image frames, and fusing the foreground image frames with the background image to obtain animation image frames; and
generating the animation file based on the play time of each of the image frames and the animation image frames and playing the animation file.

7. The animation effect generation method according to claim 1, wherein:
the animation effect generation method further comprises receiving a configuration update request comprising a new configuration file; and
the generating the animation file based on the plurality of image frames, the play time of each of the image frames and the configuration file and playing the animation file comprises:
generating a new animation file based on the new configuration file, the play time of each of the image frames and the image frame file and playing the new animation file.

8. The animation effect generation method according to claim 1, wherein the configuration file comprises an audio file, and the animation effect generation method further comprises:
detecting whether a currently playing image frame corresponds to a preset audio time point after the controlling the effect image frame(s) to play based on the preset shooting parameter;
acquiring a target audio point corresponding to the currently playing image frame in response to the currently playing image frame not corresponding to the preset audio time point; and
synchronously playing the currently playing image frame and audio file at the target audio point.

9-16. (canceled)

17. An electronic device, wherein the electronic device comprises:
a memory for storing instructions executable by a processor;
a processor for reading the executable instructions from the memory and executing the instructions to implement an animation effect generation method comprising:
acquiring an image frame file of a target object and a configuration file, wherein the image frame file comprises a plurality of image frames and a play time of each of the image frames;
generating an animation file based on the plurality of image frames, the play time of each of the image frames and the configuration file and playing the animation file;
acquiring effect image frame(s) in a process of playing the animation file; and
controlling the effect image frame(s) to play based on a preset shooting parameter.

18. A non-transitory computer-readable storage medium, wherein the storage medium stores a computer program used for executing an animation effect generation method comprising:
acquiring an image frame file of a target object and a configuration file, wherein the image frame file comprises a plurality of image frames and a play time of each of the image frames;
generating an animation file based on the plurality of image frames, the play time of each of the image frames and the configuration file and playing the animation file;
acquiring effect image frame(s) in a process of playing the animation file; and
controlling the effect image frame(s) to play based on a preset shooting parameter.

19. (canceled)

20. The electronic device according to claim 17, wherein the acquiring the effect image frame(s) in the process of playing the animation file comprises:
in the process of playing the animation file, acquiring a currently playing image frame of the animation file in response to receiving an effect input operation;
matching the currently playing image frame with the plurality of image frames to obtain a key image frame;
determining the effect image frame(s) from the plurality of image frames based on the key image frame and a preset number of image frames.

21. The electronic device according to claim 17, wherein the acquiring the effect image frame(s) in the process of playing the animation file comprises:
in the process of playing the animation file, in response to detecting a matching image frame satisfying a preset effect condition, determining the effect image frame(s) from the plurality of image frames based on the matching image frame and a preset number of image frames.

22. The electronic device according to claim 17, wherein acquiring the image frame file of the target object comprises:
collecting a plurality of color images in a scene where the target object moves based on a preset motion trajectory, and depth image(s) and transparency image(s) corresponding to at least part of the color images;
determining playing times of the color images; and
generating the image frame file according to the plurality of color images, the depth image(s) and the transparency image(s) corresponding to the at least part of the color images, and the playing times of the color images.

23. The electronic device according to claim 22, wherein the generating the image frame file according to the plurality of color images, the depth image(s) and the transparency image(s) corresponding to the at least part of the color images, and the playing times of the color images comprises:
encoding each of the color images, a depth image and a transparency image corresponding to each of the at least part of the color images respectively, and the playing times of the color images to obtain an encoded file; and
decoding the encoded file to obtain the image frame file.

24. The electronic device according to claim 17, wherein the configuration file comprises a background image frame, and the generating the animation file based on the plurality of image frames, the play time of each of the image frames and the configuration file and playing the animation file comprises:
taking the plurality of image frames as foreground image frames, and fusing the foreground image frames with the background image to obtain animation image frames; and
generating the animation file based on the play time of each of the image frames and the animation image frames and playing the animation file.

25. The electronic device according to claim 17, wherein:
the processor is further configured to receive a configuration update request comprising a new configuration file;
the generating the animation file based on the plurality of image frames, the play time of each of the image frames and the configuration file and playing the animation file comprises:
generating a new animation file based on the new configuration file, the play time of each of the image frames and the image frame file and playing the new animation file.

26. The electronic device according to claim 17, wherein the configuration file comprises an audio file, and the processor is further configured to:
detect whether a currently playing image frame corresponds to a preset audio time point after the controlling the effect image frame(s) to play based on the preset shooting parameter;
acquire a target audio point corresponding to the currently playing image frame in response to the currently playing image frame not corresponding to the preset audio time point; and
synchronously play the currently playing image frame and audio file at the target audio point.

27. The non-transitory computer-readable storage medium according to claim 18, wherein the acquiring the effect image frame(s) in the process of playing the animation file comprises:
in the process of playing the animation file, acquiring a currently playing image frame of the animation file in response to receiving an effect input operation;
matching the currently playing image frame with the plurality of image frames to obtain a key image frame;
determining the effect image frame(s) from the plurality of image frames based on the key image frame and a preset number of image frames.

28. The non-transitory computer-readable storage medium according to claim 18, wherein the acquiring the effect image frame(s) in the process of playing the animation file comprises:
in the process of playing the animation file, in response to detecting a matching image frame satisfying a preset effect condition, determining the effect image frame(s) from the plurality of image frames based on the matching image frame and a preset number of image frames.

29. The non-transitory computer-readable storage medium according to claim 18, wherein acquiring the image frame file of the target object comprises:
collecting a plurality of color images in a scene where the target object moves based on a preset motion trajectory, and depth image(s) and transparency image(s) corresponding to at least part of the color images;
determining playing times of the color images; and
generating the image frame file according to the plurality of color images, the depth image(s) and the transparency image(s) corresponding to the at least part of the color images, and the playing times of the color images.
